(19) United States
(12) Patent Application Publication
(10) Pub. No.: US 2014/0123947 A1
(43) Pub. Date: May 8, 2014

(54) LPG DIRECT INJECTION SYSTEM

(71) Applicants: HYUNDAI MOTOR COMPANY, Seoul (KR); KIA MOTORS CORPORATION, Seoul (KR); MOTONIC CORPORATION, Seoul (KR)

(72) Inventors: Jin Oh Song, Seongnam-si (KR); Sung Kun Kim, Seongnam-city (KR); Chulsoo Yook, Suwon-si (KR); Yong Deok Park, Daegu (KR); One-Gil Lee, Daegu (KR)

(73) Assignees: Hyundai Motor Company, Seoul (KR); Motonic Corporation, Seoul (KR); Kia Motors Corporation, Seoul (KR)

(21) Appl. No.: 13/749,188

(22) Filed: Jan. 24, 2013

(30) Foreign Application Priority Data
Nov. 2, 2012 (KR) 10-2012-0123619

(51) Int. Cl. F02M 39/00

(52) U.S. Cl. CPC F02M 39/00
USPC 123/446

(57) ABSTRACT

An LPG direct injection system may include an engine receiving liquefied petroleum gas (LPG) into a combustion chamber thereof, an injector adapted to inject the LPG into the combustion chamber of the engine, a high pressure fuel pump supplying high pressured LPG to the injector, a fuel tank storing the LPG for supplying to the engine, a regulator apparatus receiving the LPG from the fuel tank, controlling pressure of the received LPG, and delivering a controlled LPG to the high pressure fuel pump, a fuel supply line sequentially connecting the fuel tank, the regulator apparatus, the high pressure fuel pump, and the injector so as to supply the LPG stored in the fuel tank to the engine, and a fuel return line returning an LPG that remains in the high pressure fuel pump after pumping thereof to the fuel tank.

### CROSS-REFERENCE TO RELATED APPLICATION

The present application claims priority to Korean Patent Application No. 10-2012-0123619 filed on Nov. 2, 2012, the entire contents of which is incorporated herein for all purposes by this reference.

### BACKGROUND OF THE INVENTION

1. Field of the Invention

The present invention relates to an LPG direct injection system. More particularly, the present invention relates to a system which is adapted to directly inject liquefied petroleum gas (LPG) to an engine of a vehicle.

2. Description of Related Art

Generally, an LPG engine is an internal combustion engine using LPG instead of gasoline as fuel. In addition, the LPG engine has merits that fuel cost is less expensive, the amount of generated noxious materials is smaller, and the lifespan of an engine is longer than a gasoline engine.

In a vehicle using an LPG engine, the LPG is stored in a liquid state in a fuel tank. In addition, the LPG engine is separated to a carburetor type and a liquid phase LPG injection (LPLI) type by how fuel is supplied to an engine.

The carburetor type is adapted to vaporize the liquefied LPG stored in the fuel tank and supply the vaporized LPG to the engine. In the LPLI type, the liquefied LPG is supplied from the fuel tank to the fuel pump, the fuel pump delivers high pressure liquefied LPG to an injector, and the delivered LPG is injected by the injector.

In the LPLI type in which precise injection control is possible by an electric injection system using an LPG injector which is only for injecting LPG, exhaust gas is reduced and fuel consumption is relatively improved over those of the carburetor system.

Meanwhile, types to which the injector is applied for injecting a fuel may include a multipoint injection (MPI) type in which an injector is respectively mounted at each cylinder and a fuel is injected into each intake port, a single point injection (SPI) type in which a fuel is injected into a concurrence of intake manifolds, and a type in which a fuel is directly injected into a combustion chamber of an engine.

Particularly, research on a liquefied petroleum gas direct injection (LPDI) engine in a field of an engine of a vehicle using LPG as fuel and on a gasoline direct injection (GDI) engine in a field of an engine of a vehicle using gasoline as fuel is being actively carried out.

However, a vehicle having an LPG engine may have drawbacks that a cold starting performance is deteriorated, LPG stations are insufficiently available, and spatial utility is decreased by an LPG fuel tank. Therefore, it is required for the drawbacks of the LPG engine to be resolved or merits of the LPG engine to be maximized such that the spread of vehicles having an LPG engine is expanded. Accordingly, the importance of development and commercialization of the LPDI engine have been highlighted.

The information disclosed in this Background of the Invention section is only for enhancement of understanding of the general background of the invention and should not be taken as an acknowledgement or any form of suggestion that this information forms the prior art already known to a person skilled in the art.

### BRIEF SUMMARY

Various aspects of the present invention are directed to providing an LPG direct injection system having advantages of directly injecting LPG to a combustion chamber of an engine.

In addition, various aspects of the present invention are directed to providing an LPG direct injection system having further advantages of improving warm restarting performance and cold starting performance of an LPG engine.

In an aspect of the present invention, an LPG direct injection system may include an engine receiving liquefied petroleum gas (LPG) into a combustion chamber thereof, an injector adapted to inject the LPG into the combustion chamber of the engine, a high pressure fuel pump supplying high pressured LPG to the injector, a fuel tank storing the LPG for supplying to the engine, a regulator apparatus receiving the LPG from the fuel tank, controlling pressure of the received LPG, and delivering a controlled LPG to the high pressure fuel pump, a fuel supply line sequentially connecting the fuel tank, the regulator apparatus, the high pressure fuel pump, and the injector so as to supply the LPG stored in the fuel tank to the engine, and a fuel return line returning an LPG that remains in the high pressure fuel pump after pumping thereof to the fuel tank.

The fuel return line is formed via the regulator apparatus disposed between the high pressure fuel pump and the fuel tank, wherein pressure of the remaining LPG returned through the fuel return line is controlled by the regulator apparatus.

The high pressure fuel pump may include a fuel inlet fluid-connected with the fuel supply line so as to receive the LPG passing through the regulator apparatus, a fuel outlet adapted to supply the LPG to the injector, and a fuel recovery inlet connected with the fuel return line.

The regulator apparatus may include a first regulator fluid-connected with the fuel tank and the high pressure fuel pump via the fuel supply line, controlling pressure of the LPG supplied from the fuel tank to a set pressure, and supplying the LPG controlled to the set pressure to the high pressure fuel pump, a second regulator controlling pressure of the LPG supplied from the fuel tank to another set pressure, and supplying the LPG controlled to the other set pressure to the high pressure fuel pump, a first valve disposed between the first regulator and the high pressure fuel pump, and operating such that the LPG is selectively supplied from the first regulator to the high pressure fuel pump, and a second valve disposed between the second regulator and the high pressure fuel pump, and operating such that the LPG is selectively supplied from the second regulator to the high pressure fuel pump, wherein the pressure of LPG controlled by the second regulator is higher than the pressure of LPG controlled by the first regulator.

The system may further include a fuel supply pump mounted in the fuel tank, wherein the LPG stored in the fuel tank is delivered to the first and second regulators by pumping of the fuel supply pump.

The second regulator is disposed branched from a front and a rear of the first regulator in the fuel supply line.

The first regulator is connected between the high pressure fuel pump and the fuel tank via the fuel return line.

The first regulator controls the pressure of the LPG remaining after pumping by the high pressure fuel pump, and delivers the remaining LPG, of which pressure thereof is controlled, to the fuel tank.

The pressure of the remaining LPG controlled by the first regulator is 3 bar.

The first valve and the second valve selectively open or close the fuel supply line, and when one of the first valve and the second valve is operated so as to open the fuel supply line, the other thereof is operated so as to close the fuel supply line.

The pressure of LPG controlled by the first regulator is 3 bar.

The pressure of LPG controlled by the second regulator is 5 bar.

The system may further include a fuel supply pump mounted in the fuel tank, wherein LPG stored in the fuel tank is delivered to the regulator apparatus by pumping of the fuel supply pump.

Fuel supply of gasoline direct injection (GDI) engine is applied to the engine.

The methods and apparatuses of the present invention have other features and advantages which will be apparent from or are set forth in more detail in the accompanying drawings, which are incorporated herein, and the following Detailed Description, which together serve to explain certain principles of the present invention.

### BRIEF DESCRIPTION OF THE DRAWINGS

FIG. 1 is a block diagram of an LPG direct injection system according to an exemplary embodiment of the present invention.

It should be understood that the appended drawings are not necessarily to scale, presenting a somewhat simplified representation of various features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION

Reference will now be made in detail to various embodiments of the present invention(s), examples of which are illustrated in the accompanying drawings and described below. While the invention(s) will be described in conjunction with exemplary embodiments, it will be understood that the present description is not intended to limit the invention(s) to those exemplary embodiments. On the contrary, the invention(s) is/are intended to cover not only the exemplary embodiments, but also various alternatives, modifications, equivalents and other embodiments, which may be included within the spirit and scope of the invention as defined by the appended claims.

An exemplary embodiment of the present invention will hereinafter be described in detail with reference to the accompanying drawings.

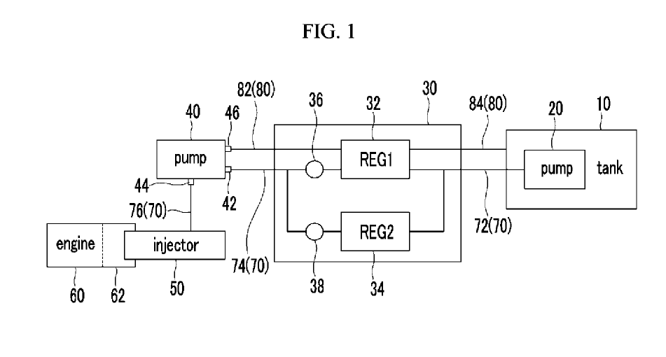

FIG. 1 is a block diagram of an LPG direct injection system according to an exemplary embodiment of the present invention.

The LPG direct injection system according to an exemplary embodiment of the present invention relates to a liquefied petroleum gas direct injection (LPDI) engine 60 in which a fuel supply type of a gasoline direct injection (GDI) engine is applied to a liquefied petroleum gas (LPG) engine, and devices for supplying a fuel to an LPDI engine 60.

As shown in FIG. 1, the LPG direct injection system according to an exemplary embodiment of the present invention includes a fuel tank 10, a fuel supply pump 20, a regulator apparatus 30, a high pressure fuel pump 40, an injector 50, and an LPDI engine 60.

The fuel tank 10 is a bomb in which liquefied LPG is stored. In addition, the LPG stored in the fuel tank 10 is used as a fuel of the LPDI engine 60.

The fuel supply pump 20 is a pump mounted in the fuel tank 10. In addition, the fuel supply pump 20 pumps the liquefied LPG stored in the fuel tank 10 so as to supply LPG to the LPDI engine 60.

The regulator apparatus 30 controls pressure of the LPG pumped from the fuel supply pump 20. In addition, the regulator apparatus 30 is connected with the fuel supply pump 20 through a fuel supply line 70. The fuel supply line 70 is a passage for LPG which is formed for delivering the LPG stored in the fuel tank 10 to the LPDI engine 60. Further, the liquefied LPG pumped by the fuel supply pump 20 is delivered to the regulator apparatus 30 through the fuel supply line 70. The regulator apparatus 30 is connected with the fuel tank 10 through a fuel return line 80.

The high pressure fuel pump 40 is a pump which performs pumping so as to deliver high pressure liquefied LPG. In addition, the high pressure fuel pump 40 is connected with the regulator apparatus 30 through the fuel supply line 70. That is, the liquefied LPG of which pressure thereof is controlled via the regulator apparatus 30 is supplied to the high pressure fuel pump 40 through the fuel supply line 70. The high pressure fuel pump 40 is connected with the regulator apparatus 30 through the fuel return line 80. Herein, the fuel return line 80 is another passage for LPG which is formed for delivering LPG remaining after pumping by the high pressure fuel pump back to the fuel tank 10. The return of fuel in which the remaining LPG is delivered back to the fuel tank 10 is performed when LPG pressure in an engine is higher than LPG pressure in the fuel tank 10 and is the same as or more than a set value. The return of fuel is obvious to a person skilled in the art, so a detailed description thereof will be omitted.

The injector 50 injects fuel to the LPDI engine 60. In addition, the injector 50 is connected with the high pressure fuel pump 40 through the fuel supply line 70. That is, the high pressure LPG delivered from the high pressure fuel pump 40 is supplied to the injector 50 through the fuel supply line 70.

The LPDI engine 60 is one in which fuel is directly injected into a combustion chamber 62 of the engine 60 like the GDI engine. That is, the injector 50 is inserted into a cylinder head of the LPDI engine 60, and an injection nozzle of the injector 50 is disposed so as to directly inject LPG into the combustion chamber 62. Even though a rough block diagram according to a connection of the injector 50 and the LPDI engine 60 shown in FIG. 1, the disposition of an injector such that a fuel is directly injected into a combustion chamber of an engine is obvious to a person skilled in the art. Meanwhile, the injector 50 may be an LPG injector which is only for injecting LPG.

The regulator apparatus 30 includes a first regulator 32, a second regulator 34, a first valve 36, and a second valve 38. In addition, the fuel supply line 70 includes a first supply line 72, a second supply line 74, and a third supply line 76. Further, the fuel return line 80 includes a first return line 82, and a second return line 84. Meanwhile, a fuel inlet 42, a fuel outlet 44, and a fuel recovery inlet 46 are formed at the high pressure fuel pump 40.

The first regulator 32 and the second regulator 34 are mounted in the regulator apparatus 30.

The first regulator 32 controls pressure of LPG such that the LPG supplied from the fuel supply pump 20 to the regulator apparatus 30 has a set pressure. In addition, the pressure of the LPG controlled by the first regulator 32 may be 3 bar.

The second regulator 34 controls pressure of LPG such that the LPG supplied from the fuel supply pump 20 to the regulator apparatus 30 has another set pressure. In addition, the pressure of the LPG controlled by the second regulator 34 may be 5 bar.

The first supply line 72 is the fuel supply line 70 for connecting the fuel supply pump 20 and the regulator apparatus 30 with each other. In addition, one end of the first supply line 72 is connected with the fuel supply pump 20 in the fuel tank 10, and the other end of the first supply line 72 is branched into two parts in the regulator apparatus 30. Further, the branched ends of the first supply line 72 are respectively connected to the first regulator 32 and the second regulator 34.

The second supply line 74 is the fuel supply line 70 for connecting the regulator apparatus 30 and the high pressure fuel pump 40 with each other. In addition, one end of the second supply line 74 is branched into two parts in the regulator apparatus 30, and the other end of the second supply line 74 is connected with the fuel inlet 42 formed at the high pressure fuel pump 40. Further, the branched ends of the second supply line 74 are respectively connected to the first regulator 32 and the second regulator 34. Herein, the fuel inlet 42 of the high pressure fuel pump 40 is an inlet for LPG which is formed such that LPG passing through the regulator apparatus 30 is supplied to the high pressure fuel pump 40.

The first valve 36 is disposed on one of the branched ends of the second supply line 74 which is connected with the first regulator 32. In addition, the first valve 36 selectively opens/closes the one end of the second supply line 74. That is, the first valve 36 selectively blocks supply of liquefied LPG passing through the first regulator 32 to the high pressure fuel pump 40.

The second valve 38 is disposed on the other of the branched ends of the second supply line 74 which is connected with the second regulator 34. In addition, the second valve 38 selectively opens/closes the other end of the second supply line 74. That is, the second valve 38 selectively blocks supply of liquefied LPG passing through the second regulator 34 to the high pressure fuel pump 40.

The third supply line 76 is the fuel supply line 70 connecting the high pressure fuel pump 40 to the injector 50. In addition, one end of the third supply line 76 is connected with the fuel outlet 44 formed at the high pressure fuel pump 40, and other end of the third supply line 76 is connected with the injector 50. Herein, the fuel outlet 44 of the high pressure fuel pump 40 is an outlet for LPG which is formed such that LPG pumped by the high pressure fuel pump 40 is supplied to the injector 50.

The first return line 82 is the fuel return line 80 connecting the high pressure fuel pump 40 and the regulator apparatus 30 with each other. In addition, one end of the first return line 82 is connected with the fuel recovery inlet 46 formed at the high pressure fuel pump 40, and other end of the first return line 82 connected with the first regulator 32 in the regulator apparatus 30. Herein, the fuel recovery inlet 46 is a hole which is formed such that the LPG that remains in the high pressure fuel pump after pumping thereof is returned to the first regulator 32.

The second return line 84 is the fuel return line 80 connecting the regulator apparatus 30 and the fuel tank 10 with each other. In addition, one end of the second return line 84 is connected with the first regulator 32 in the regulator apparatus 30, and other end of the second return line 84 is connected to the fuel tank 10. That is, the remaining LPG that is returned from the high pressure fuel pump 40 is restored into the fuel tank 10 via the first regulator 32.

According to the above-mentioned description regarding the fuel supply line 70 and fuel return line 80, all of the one ends represent the portions through which liquefied LPG flows into the passages, and all of the other ends represent the portions through which liquefied LPG flows from the passages.

The LPG direct injection system according to an exemplary embodiment of the present invention is adapted to supply liquefied LPG from the fuel supply pump 20 to the first regulator 32 during cold starting and warm restarting of the LPDI engine 60. In addition, the first regulator 32 supplies the liquefied LPG controlled to the set pressure to the high pressure fuel pump 40. That is, the first valve 36 opens the fuel supply line 70 and the second valve 38 closes the fuel supply line 70 during the cold starting of the LPDI engine 60.

Therefore, liquefied LPG can be quickly supplied from the regulator apparatus 30 to the high pressure fuel pump 40. That is, the starting performance of the LPDI engine 60 is improved. In addition, LPG vaporized in the fuel supply line 70 can be rapidly returned to the fuel tank 10. Further, a load of the high pressure fuel pump 40 and the fuel supply pump 20 is reduced, and thus fuel consumption is improved.

The LPG direct injection system according to an exemplary embodiment of the present invention is adapted to return the remaining LPG into the fuel tank via the first regulator 32 when the remaining LPG is returned from the high pressure fuel pump 40. That is, the set pressure of remaining LPG that is controlled via the first regulator 32 is delivered to the fuel tank. Therefore, rapid return of the LPG remaining after pumping by the high pressure fuel pump 40 is possible.

The LPG direct injection system according to an exemplary embodiment of the present invention is adapted to supply liquefied LPG from the fuel supply pump 20 to the second regulator 34 when the LPDI engine 60 is operated at a high load and with high power. In addition, the second regulator 34 supplies the liquefied LPG controlled by the other set pressure to the high pressure fuel pump 40. That is, the second valve 38 opens the fuel supply line 70 and the first valve closes the fuel supply line 70 when the LPDI engine 60 is operated at a high load and with high power. Meanwhile, the pressure of the liquefied LPG controlled by the second regulator 34 may be higher than the pressure of the liquefied LPG controlled by the first regulator 32. In other words, the set pressure of the first regulator 32 may be lower than the set pressure of the second regulator 34.

Therefore, a time for liquefying the LPG that is vaporized in the high pressure fuel pump 40 can be shortened. In addition, the starting performance of the LPDI engine 60 is improved according to the time for liquefying the vaporized LPG in the LPDI engine 60.

The operation of the first valve 36 and the second valve 38 may be controlled by a general electronic control unit (ECU).

According to an exemplary embodiment of the present invention, LPG is directly injected into the combustion chamber 62 of the engine 60, and thus output of the engine 60 can be increased and fuel consumption may be improved. Further, the compression ratio is increased and the amount of exhaust gas is decreased. In addition, the regulator apparatus 30 in which the variable control is possible is applied, and thus the warm restarting performance of the LPG engine is improved and the cold starting performance is upgraded.

For convenience in explanation and accurate definition in the appended claims, the terms “upper”, “lower”, “inner” and “outer” are used to describe features of the exemplary embodiments with reference to the positions of such features as displayed in the figures.

The foregoing descriptions of specific exemplary embodiments of the present invention have been presented for purposes of illustration and description. They are not intended to be exhaustive or to limit the invention to the precise forms disclosed, and obviously many modifications and variations are possible in light of the above teachings. The exemplary embodiments were chosen and described in order to explain certain principles of the invention and their practical application, to thereby enable others skilled in the art to make and utilize various exemplary embodiments of the present invention, as well as various alternatives and modifications thereof. It is intended that the scope of the invention be defined by the Claims appended hereto and their equivalents.

What is claimed is:

1. An LPG direct injection system comprising:
an engine receiving liquefied petroleum gas (LPG) into a combustion chamber thereof;
an injector adapted to inject the LPG into the combustion chamber of the engine;
a high pressure fuel pump supplying high pressured LPG to the injector;
a fuel tank storing the LPG for supplying to the engine;
a regulator apparatus receiving the LPG from the fuel tank, controlling pressure of the received LPG, and delivering a controlled LPG to the high pressure fuel pump;
a fuel supply line sequentially connecting the fuel tank, the regulator apparatus, the high pressure fuel pump, and the injector so as to supply the LPG stored in the fuel tank to the engine; and
a fuel return line returning an LPG that remains in the high pressure fuel pump after pumping thereof to the fuel tank.

2. The system of claim 1,
wherein the fuel return line is formed via the regulator apparatus disposed between the high pressure fuel pump and the fuel tank, and
wherein pressure of the remaining LPG returned through the fuel return line is controlled by the regulator apparatus.

3. The system of claim 1, wherein the high pressure fuel pump includes:
a fuel inlet fluid-connected with the fuel supply line so as to receive the LPG passing through the regulator apparatus;
a fuel outlet adapted to supply the LPG to the injector; and
a fuel recovery inlet connected with the fuel return line.

4. The system of claim 1, wherein the regulator apparatus includes:
a first regulator fluid-connected with the fuel tank and the high pressure fuel pump via the fuel supply line, controlling pressure of the LPG supplied from the fuel tank to a set pressure, and supplying the LPG controlled to the set pressure to the high pressure fuel pump;
a second regulator controlling pressure of the LPG supplied from the fuel tank to another set pressure, and supplying the LPG controlled to the other set pressure to the high pressure fuel pump;
a first valve disposed between the first regulator and the high pressure fuel pump, and operating such that the LPG is selectively supplied from the first regulator to the high pressure fuel pump; and
a second valve disposed between the second regulator and the high pressure fuel pump, and operating such that the LPG is selectively supplied from the second regulator to the high pressure fuel pump,
wherein the pressure of LPG controlled by the second regulator is higher than the pressure of LPG controlled by the first regulator.

5. The system of claim 4, further including a fuel supply pump mounted in the fuel tank, wherein the LPG stored in the fuel tank is delivered to the first and second regulators by pumping of the fuel supply pump.

6. The system of claim 4, wherein the second regulator is disposed branched from a front and a rear of the first regulator in the fuel supply line.

7. The system of claim 4, wherein the first regulator is connected between the high pressure fuel pump and the fuel tank via the fuel return line.

8. The system of claim 7, wherein the first regulator controls the pressure of the LPG remaining after pumping by the high pressure fuel pump, and delivers the remaining LPG, of which pressure thereof is controlled, to the fuel tank.

9. The system of claim 8, wherein the pressure of the remaining LPG controlled by the first regulator is 3 bar.

10. The system of claim 4, wherein the first valve and the second valve selectively open or close the fuel supply line, and when one of the first valve and the second valve is operated so as to open the fuel supply line, the other thereof is operated so as to close the fuel supply line.

11. The system of claim 4, wherein the pressure of LPG controlled by the first regulator is 3 bar.

12. The system of claim 4, wherein the pressure of LPG controlled by the second regulator is 5 bar.

13. The system of claim 1, further including a fuel supply pump mounted in the fuel tank, wherein LPG stored in the fuel tank is delivered to the regulator apparatus by pumping of the fuel supply pump.

14. The system of claim 1, wherein fuel supply of gasoline direct injection (GDI) engine is applied to the engine.
